(19) United States
(12) Patent Application Publication
(10) Pub. No.: US 2015/0071597 A1
(43) Pub. Date: Mar. 12, 2015

(54) OPTICAL FIBER CASSETTE SYSTEMS WITH FIBER RETAINING COVERS

(71) Applicant: CORNING OPTICAL COMMUNICATIONS LLC, Hickory, NC (US)

(72) Inventors: Hubert Blair Beamon, Watauga, TX (US); William Julius McPhil Giraud, Azle, TX (US); Diana Rodriguez, Fort Worth, TX (US)

(21) Appl. No.: 14/474,735

(22) Filed: Sep. 2, 2014

Related U.S. Application Data
(60) Provisional application No. 61/874,468, filed on Sep. 6, 2013.

(51) Int. Cl. G02B 6/44

(52) U.S. Cl. CPC G02B 6/4453
USPC 385/135

(57) ABSTRACT

A drop handle includes a base having first and second ends and a cover latch. A cover is connected to the base and comprises a securing latch positioned on an inner surface and configured to engage with the cover latch of the base to secure the cover to the base. A flexible retainer is removably attached to the base. The drop handle further includes a first connecting member comprising a first hinge that is configured to rotatably connect the drop handle to a cassette and operable to lock the drop handle in a first position and a second position, a second connecting member comprising a second hinge that is configured to rotatably connect the drop handle to the cassette, and a release aperture disposed on at least one of the connecting members and configured to receive a corresponding release protrusion on the cassette.

### RELATED APPLICATIONS

This application claims the benefit of priority under 35 U.S.C. §119 of U.S. Provisional Application No. 61/874,468 filed on Sep. 6, 2013, the content of which is relied upon and incorporated herein by reference in its entirety.

### BACKGROUND

1. Field of the Disclosure

The disclosure relates generally to optical cable apparatuses, and more particularly to fiber optic cassette systems with fiber optic protective covers.

2. Technical Background

In optical cable networking apparatuses, including convergence points and distribution frames, there is a constant demand for apparatuses permitting high-density distribution with very high fiber termination counts in a small, confined volume. To accomplish the high-density distribution with high fiber termination counts requires efficient utilization of space with due regard to constraints on optical cables such as minimum bending radius. As such, ongoing needs exist for optical cable networking apparatus that can effectively utilize a confined volume and easily identify individual optical cables, while simultaneously protecting the optical cables from damage.

### SUMMARY

Some embodiments of the disclosure relate to drop handles for fiber optic cassette systems. The drop handle comprises a base having a first end, a second end, and a cover latch. The drop handle includes a cover connected to the base, the cover comprising a securing latch positioned on an inner surface, wherein the securing latch is configured to engage with the cover latch of the base to secure the cover to the base in a secured position, and a flexible retainer removably attached to the base and configured to contact the cover in the secured position. The drop handle further includes a first connecting member positioned near the first end of the base, the first connecting member comprising a first hinge that is configured to rotatably connect the drop handle to a cassette, the hinge operable to releasably lock the drop handle in a first position and a second position, a second connecting member positioned near the second end of the base, the second connecting member comprising a second hinge that is configured to rotatably connect the drop handle to the cassette, and a release aperture disposed on at least one of the first and second connecting members, the release aperture configured to receive a corresponding release protrusion on the cassette.

In another embodiment, a drop handle comprising a base comprising a first end, a second end, and a cover latch. The drop handle includes a protective cover hingedly attached to the base forming an optical fiber cavity, the protective cover comprising a securing latch configured to engage the cover latch of the base and secure the protective cover in a secured position, a first connecting member positioned near the first end of the base, the first connecting member comprising a first hinge that is configured to rotatably connect the drop handle to a cassette, the first hinge operable to releasably lock the drop handle in a first position and a second position, and a first release aperture configured to engage with a corresponding release protrusion on a cassette, and a second connecting member positioned near the second end of the base, the second connecting member comprising a second hinge that is configured to rotatably connect the drop handle to the cassette, the second hinge operable to releasably lock the drop handle in the first position and the second position, and a second release aperture configured to engage with a corresponding release protrusion on a cassette. The second release aperture is opposite and axially-aligned with the first release aperture, and the protective cover is rotatable, with respect to the base, from the secured position to an unsecured position.

Additional embodiments of the disclosure also relate to fiber optic cassette systems for optical cables and optical devices. The fiber optic cassette systems according to such embodiments include a cassette body, a first connecting arm disposed at one end of the cassette body, a second connecting arm disposed at an end of the cassette body opposite the first connecting arm, and a plurality of adapters positioned in between the first connecting arm and the second connecting arm. The cassette system also includes a drop handle comprising a base comprising a first end, a second end, and a cover latch, a cover connected to the base, the cover comprising a securing latch positioned on an inner surface, wherein the securing latch is configured to engage with the cover latch of the base to secure the cover to the base in a secured position. The drop handle includes a flexible retainer removably attached to the base and configured to contact the cover in the secured position, a first connecting member positioned near the first end of the base, the first connecting member comprising a first hinge that is configured to rotatably connect the drop handle to the cassette body, the first hinge operable to releasably lock the drop handle in a first position and a second position, a second connecting member positioned near the second end of the base, the second connecting member comprising a second hinge that is configured to rotatably connect the drop handle to the cassette body, the second hinge operable to releasably lock the drop handle in the first position and the second position, and a first release aperture disposed on the first connecting member and a second release aperture disposed on the second connecting member, the first and second release apertures configured to receive corresponding release protrusions on the cassette body. The first connecting arm comprises a first hinge receiving feature and a first release protrusion, the first hinge receiving feature configured to receive the first hinge of the drop handle and the first release protrusion configured to engage the first release aperture of the drop handle. The second connecting arm comprises a second hinge receiving feature and a second release protrusion, the second hinge receiving feature configured to receive the second hinge of the drop handle and the second release protrusion configured to engage the second release aperture of the drop handle. The drop handle is configured to rotate relative to the cassette body between the first position and the second position.

Additional features and advantages will be set forth in the detailed description which follows, and in part should be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a perspective view of a fiber optic cassette system including a fiber optic cassette and a drop handle in a stored position according to some embodiments described herein;

FIG. 2 is a perspective view of the fiber optic cassette system of FIG. 1 in an access position according to some embodiments described herein;

FIG. 3 is a perspective view of the drop handle of FIG. 1 according to some embodiments described herein;

FIG. 4 is a detail view of a connecting member of a drop handle and a connecting arm of a cassette body according to some embodiments described herein;

FIG. 5 is a perspective view of a cover of the drop handle of FIG. 1 according to some embodiments described herein;

FIG. 6 is a side view of the fiber optic cassette system of FIG. 1, showing the cover in a first position according to some embodiments described herein;

FIG. 7 is a side view of the fiber optic cassette system of FIG. 1, showing the cover moving between the first position of FIG. 6 to a second position of FIG. 8 according to some embodiments described herein;

FIG. 8 is a side view of the fiber optic cassette system of FIG. 1, showing the cover in a second position according to some embodiments described herein; and

FIG. 9 is a side view of the fiber optic cassette system of FIG. 1, showing the drop handle in a first position according to some embodiments described herein;

FIG. 10 is a side view of the fiber optic cassette system of FIG. 1, showing the drop handle moving between the first position of FIG. 9 to a second position of FIG. 11 according to some embodiments described herein; and

FIG. 11 is a side view of the fiber optic cassette system of FIG. 1, showing the drop handle in a second position according to some embodiments described herein.

### DETAILED DESCRIPTION

Embodiments of fiber optic cassette systems with drop handles for optical cables and optical devices will now be described with reference to the figures.

Cartesian axes are shown in the figures for the sake of reference only and are not intended to be limiting with respect to direction or orientation. Additionally, for sake of reference only and not by way of limitation, the Cartesian axes shown in the figures include arrows that consistently define a particular direction with respect to each axis in all figures that depict the same object in different orientations. Throughout this disclosure, relational terms will be used by a convention in view of the Cartesian axes of the figures and the positive directions indicated by the arrows. According to the convention, relationships relative to the x-axis of any object may be expressed using terms such as left, right, to the left of, or to the right of. According to the convention, relationships relative to the y-axis of any object may be expressed using terms such as front, back, in front of or proximal to, or behind or distal to. According to the convention, relationships relative to the z-axis of any object may be expressed using terms such as top, bottom, above, below, over, or under. Neither the convention nor the terms used to express various relationships are intended to limit any object or component thereof to a direction or orientation in construction or in use.

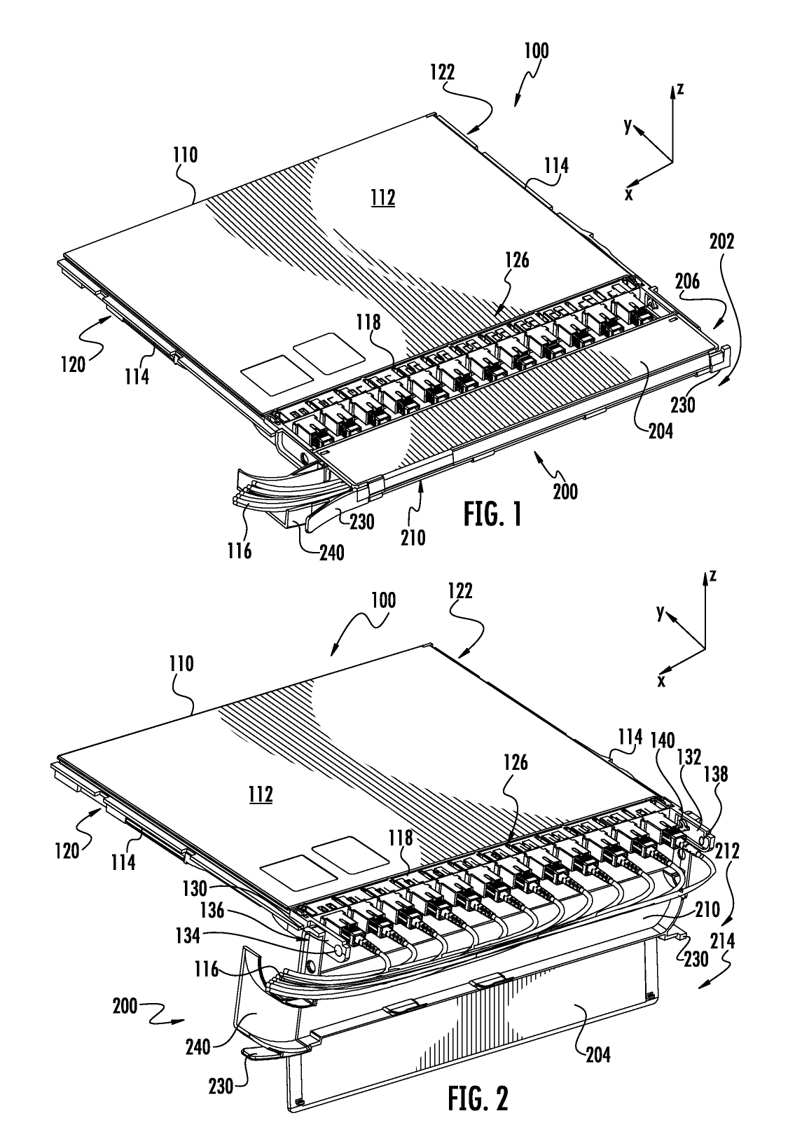

Referring now to FIGS. 1 and 2, one embodiment of a fiber optic cassette system 100 including a fiber optic cassette 110 and a drop handle 200 is illustrated. FIG. 1 illustrates the drop handle 200 of the fiber optic cassette system 100 in a stored position 202 relative to the fiber optic cassette 110, and a cover 204 of the drop handle 200 in a secured position 206, relative to a base 210 of the drop handle 200. FIG. 2 illustrates the drop handle 200 of the fiber optic cassette system 100 in an access position 212 relative to the fiber optic cassette 110, and the cover 204 of the drop handle 200 in an unsecured position 214 relative to the base 210 of the drop handle 200. The drop handle 200 may protect or cover a portion of an adapter bank 126 of the fiber optic cassette 110 when in the stored position 202.

The fiber optic cassette 110 includes a cassette body 112. The cassette body 112 includes a first end 120, a second end 122, and a front surface 118 at a front end of the cassette body 112. The front surface 118 may be positioned in between and transverse to the first end 120 and the second end 122 of the cassette body 112. The cassette body 112 may be, for example, a box-like structure or housing with an inner cavity (not shown) configured to hold or guide fiber optic cables or optical components positioned within the cassette body 112, such that the optical fibers appropriately route between and connect to adapters and to optical components positioned in the cassette body 112. The cassette body 112 may be formed from, for example, plastic or metal or a combination thereof. The cassette body 112 may be configured to engage with and position on or in a fiber optic distribution frame (not shown) or a fiber optic local convergence point, such as an outdoor fiber optic cabinet (not shown). Accordingly, the fiber optic cassette 110 may include framework operable for positioning in such as a cabinet including, as a non-limiting example, sliding rails 114 positioned on the first and second ends 120, 122 of the cassette body 112 to enable the fiber optic cassette 110 to slide into and out of fiber optic distribution frames or cabinets.

As will be described in greater detail below herein, the fiber optic cassette 110 may be configured to receive and connect to the adapter bank 126 such that the adapter bank 126 is disposed through the front surface 118. The adapter bank 126 may be comprised of a plurality of individual adapters or a plurality of adaptors that are ganged together as an integral adaptor assembly, with each adapter individually configured to receive a fiber optic connector attached to an end of a fiber optic cable 116, and optically connect it to a fiber optic connector attached to an end of a fiber optic cable inside of the fiber optic cassette 110 for connecting external devices (not shown) to optical cables within the fiber optic cassette 110. The adapter bank 126 may be configured to engage with a standard fiber optic connector such as ST, SC, LC, FC or MTP connectors, or the like.

In addition to protecting cables 116, in embodiments, the drop handle 200 may also be configured to organize, guide, and identify the cables 116 connected to the adapter bank 126 with a cable guide 240. For example, if the cables 116 connected to the adapter bank 126 are permitted to extend straight out of the adapter bank 126 (i.e., if the drop handle 200 were not present in FIG. 1) the cables 116 may extend out in the y-direction and hang down in the z-direction, thereby obstructing access to pluralities of adapters in other cassettes that might be present in a housing (not depicted). The drop handle 200 may also include identification labels on the cover 204 to identify the cable 116, as discussed below. Therefore, in some embodiments, the drop handle 200 guides the cables 116 connected to the adapter bank 126 away from and to one side (i.e., the left or right side in the x-direction) of the cassette. In other embodiments, the drop handle 200 may guide the cables 116 connected to the adapter bank 126 to both sides of the cassette body 112. For example, in such embodiments, one or more of the cables 116 connected to the adapter bank 126 may be guided by the drop handle to the left side of the cassette body 112 in the x-direction and one or more of the cables 116 connected to the adapter bank 126 may be guided to the right side of the cassette body 112 in the x-direction.

Referring now to FIG. 2, the fiber optic cassette 110 includes a first connecting arm 130 disposed at the first end 120 of the cassette body 112, and a second connecting arm 132 disposed at the second end 122 of the cassette body 112, opposite the first connecting arm 130. The adapter bank 126 may be positioned in between the first connecting arm 130 and the second connecting arm 132. The first and second connecting arms 130, 132 may extend from the cassette body 112 and may be extruded as part of the cassette body 112 or may be separate components attached to the cassette body 112.

The first connecting arm 130 may include a first release protrusion 134 and a first hinge receiving feature 136 and the second connecting arm 132 may include a second release protrusion 138 and a second hinge receiving feature 140, as discussed below. In other embodiments, additional or fewer connecting arms may be included. In some embodiments, the first and second connecting arms 130, 132 may comprise the same components (e.g. release protrusions and hinge receiving features), while in other embodiments, the first and second connecting arms 130, 132 may not comprise the same components. Additionally, in some embodiments the hinge receiving features 136, 140 may include one or more locking detents (e.g., detents 251, 253, 255, 257, not shown in FIG. 2) which engage one or more locking tabs (e.g., locking tabs 270, 272, not shown in FIG. 2) of the drop handle 200 to hold the drop handle 200 in one or more specific positions, as discussed below (e.g., stored position 202 and access position 212).

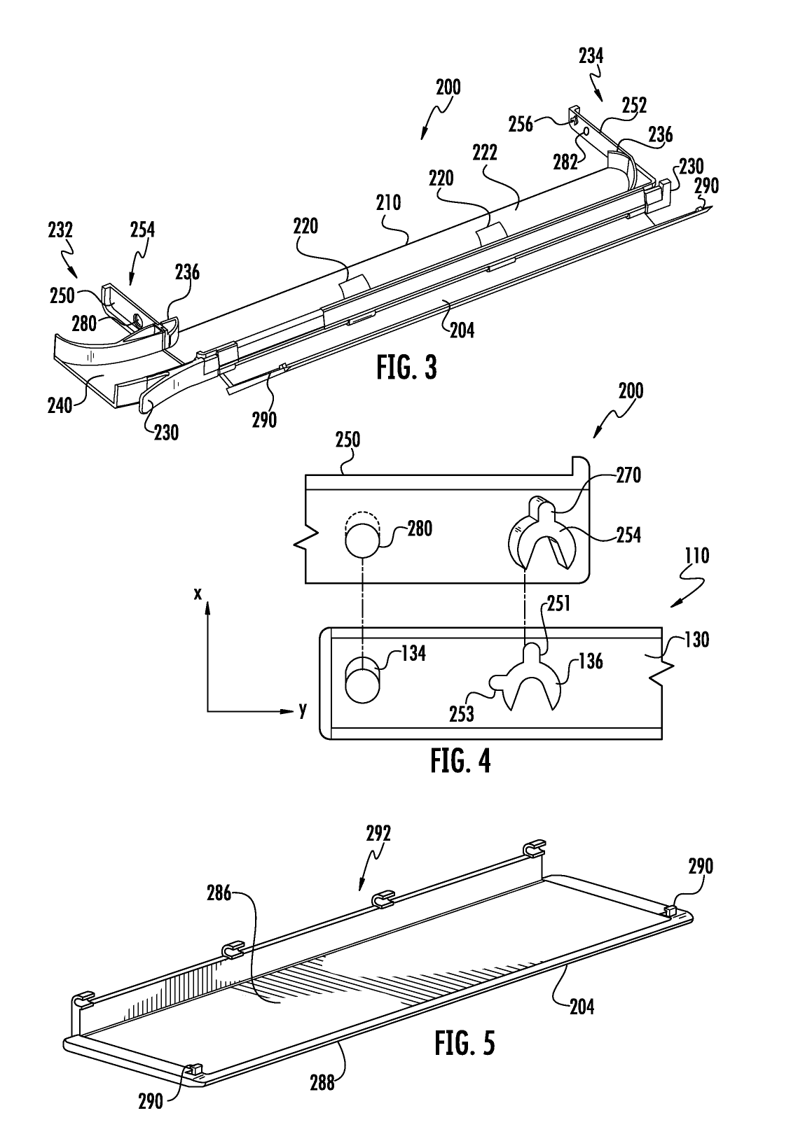

In the illustrated embodiment, the first and second connecting arms 130, 132 are configured to connect the drop handle 200 to the cassette body 112 by engaging with corresponding connecting members of the drop handle 200. The first and second connecting arms 130, 132 may further be configured to allow the drop handle 200 to rotate, pivot, or slide with respect to the cassette body 112, as discussed herein. For example, the first and second release protrusions 134, 138 may allow a user to apply a force and temporarily displace the first or second connecting arms 130, 132 in the x-direction, which may allow the drop handle 200 to be disengaged from the stored position 202 by creating a clearance between the release protrusion 134 or 138 and a corresponding release aperture on the drop handle 200. Illustrative embodiments of the connection mechanisms between the drop handle 200 and the cassette body 112 are discussed in detail with reference to FIGS. 3-4.

Still referring to FIG. 2, the drop handle 200 is illustrated in a second position, or the access position 212. In the access position 212, the drop handle 200 allows a user to access the adapter bank 126 positioned on the front surface 118 of the cassette body 112. The drop handle 200 in FIG. 2 is also illustrated with the cover 204 in the unsecured position 214, as described below. Although the access position 212 is illustrated with the drop handle 200 positioned substantially normal to the cassette body 112, the access position 212 may be any position other than the stored position 202. Further, the unsecured position 214 for the cover 204 may be any position other than the secured position 206.

Referring now to FIG. 3, the drop handle 200 of the fiber optic cassette system 100 is illustrated in isolation (i.e., separated from the cassette system 100). The drop handle 200 comprises the base 210, the cover 204, flexible retainers 220, and at least one finger grip 230. The base 210 may form a tray-like structure and may form an optical fiber cavity 222 configured to guide or retain fiber optic cables (e.g., fiber optic cables 116 shown in FIG. 2) connected to the plurality of adapters disposed on the cassette body 112. The base 210 includes a first end 232, a second end 234, and a cover latch 236. Each cover latch 236 of the base 210 is configured to engage with a corresponding securing latch 290 of the cover 204, as discussed below.

The first end 232 of the drop handle 200 may correspond to the first end 120 of the cassette body 112 (shown in FIGS. 1 and 2), while the second end 234 of the drop handle 200 may correspond to the second end 122 of the cassette body 112. The first end 232 of the base 210 may comprise the cable guide 240. The cable guide 240 may guide the fiber optic cables 116 connected to the adapter bank 126 on the cassette body 112. The cable guide 240 may be configured to ensure the fiber optic cables 116 positioned on the cable guide 240 do not exceed a certain predetermined curvature radius or otherwise become damaged. In some embodiments, the second end 234 may also comprise a cable guidance apparatus (not shown).

A first connecting member 250 is positioned at or near the first end 232 of the base, and a second connecting member 252 is positioned at or near the second end 234 of the base 210. The first and second connecting members 250, 252 may extend from the base 210 of the drop handle 200. The first connecting member 250 may include a first hinge 254, and the second connecting member 252 may include a second hinge 256. The first and second hinges 254, 256 may be the same in some embodiments, or may be different in other embodiments. The first and second hinges 254, 256 may be configured to connect the drop handle 200 to the fiber optic cassette 110 (e.g., FIGS. 1, 2) by engaging with the corresponding hinge receiving features 136, 140 of the cassette body 112. In other embodiments, more or fewer connecting members may be included in the drop handle 200. In the illustrated embodiment, the first and second connecting members 250, 252, along with their respective first and second hinges 254, 256, may rotatably connect the drop handle 200 to the fiber optic cassette 110 (e.g., FIGS. 1, 2). In other embodiments, the first and second connecting members 250, 252 may slidably connect the drop handle 200 to the fiber optic cassette 110 (e.g., FIGS. 1, 2) and may or may not permit the drop handle 200 to stop or releasably lock into one or more specific positions relative to the cassette 110. It should be understood that the first and second hinges 254, 256 may be disposed on the cassette body 112 and the corresponding release apertures may be disposed on the drop handle 200. Further, it should be understood that other hinged connections may be used without deviating from the scope of embodiments described herein. The hinged connection between the drop handle 200 and the cassette body 112 will be described in more detail below.

The first connecting member 250 may further include a first release aperture 280 and the second connecting member 252 may further include a second release aperture 282. The first and second release apertures 280, 282 may be opposite and axially aligned. The first and second release apertures 280, 282 may receive the corresponding release protrusions 134, 138 on the first and second connecting arms 130, 132 of the cassette body 112 (e.g., FIGS. 1, 2) to form a snap-fit or detent-like connection. The first and second release apertures 280, 282 may be circular, rectangular, triangular, or may have another geometry that corresponds with the geometry of the first and second release protrusions on the connecting arms of the fiber optic cassette.

Further, the release aperture 280 of the first connecting member 250 of the drop handle 200 may receive the first release protrusion 134 of the cassette body 112. The first release protrusion 134 may be pressed in the x-direction by a user, temporarily displacing the first connecting arm 130, and allowing the first connecting member 250 to move with respect to the first connecting arm 130, as the first release protrusion 134 is no longer securing the arm and the member to each other. Some embodiments may only include one hinge, while others may include one hinge per connecting member.

Referring briefly to FIG. 4, the first hinge 254 may engage or insert into the first hinge receiving feature 136 of the first connecting arm 130 of the fiber optic cassette 110 (e.g., FIGS. 1, 2), and may be operable to releasably lock the drop handle 200 in a first position or a second position. For example, the first hinge 254 may comprise a first locking tab 270 that can engage a first detent 251 of the first hinge receiving feature 136 of the first connecting arm 130 to hold or releasably lock the drop handle 200 in the stored position 202 as shown in FIG. 1. The first hinge receiving feature 136 may also comprise a second detent 253 that is angularly spaced from the first detent 251 such that when the drop handle 200 is moved from the stored position 202, the first locking tab 270 may disengage from the first detent 251 and move, rotate, and or pivot until the first locking tab 270 engages the second detent 253. When the first locking tab 270 is engaged with the second detent 253, it holds or releasably locks the drop handle 200 in the access position 212 as shown in FIG. 2.

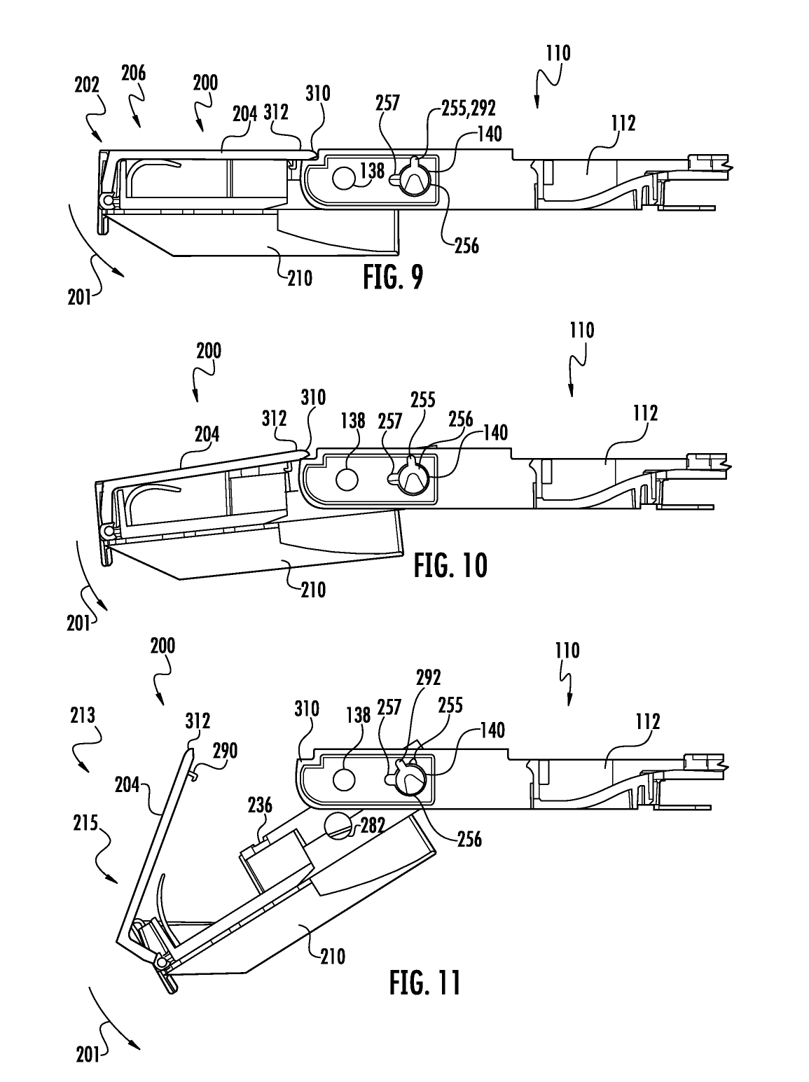

Optionally, the second hinge 256 may also include a second locking tab 272 (shown in FIGS. 9-11) that can engage a respective first detent 255 disposed on the second hinge receiving feature 140 to hold or releasably lock, separately or in combination with the first hinge 254, the drop handle 200 in the stored position 202, and a second detent 257 disposed on the second hinge receiving feature 140 (spaced from the first detent 255) to hold or releasably lock the drop handle 200 in the access position 212. The first and second detents 251, 253, 255, 257 may provide a friction fit or interference fit, for example, with the respective locking tabs 270, 272 and may provide a force that arrests motion of the drop handle 200 with respect to the cassette body 112, providing a releasable locking function.

Referring back to FIG. 3, the drop handle 200 also includes flexible retainers 220. The flexible retainers 220 may be attached to the base 210 and configured to contact the cover 204 of the base 210 when the cover 204 is in the secured position 206 as shown in FIG. 1. The flexible retainers 220 may be removably attached to the base 210 and may be replaceable. The flexible retainers 220 may also be overmolded to the base 210. Although the drop handle 200 is illustrated with two flexible retainers 220, other embodiments may include multiple flexible retainers, for example, or a single flexible retainer extending along the width of the drop handle 200. Additionally, the flexible retainers 220 may be attached to the cover 204 instead of the base 210.

The drop handle 200 also includes at least one finger grip 230. In FIG. 3, the finger grips 230 are shown positioned near the cable guide 240 near the first end 232 of the base 210 and at the second end 234 of the base 210. The finger grips 230 may allow users to manually operate or move the drop handle 200, for example from the stored position 202 to the access position 212. The finger grip 230 may be a finger tab, as shown near the first end 232, or may be another device that allows users to manipulate the drop handle position.

Referring now to FIG. 5, the cover 204 of the drop handle 200 is depicted in isolation (i.e., separated from the drop handle 200). The cover 204 may be a protective cover and may cover a portion of the fiber optic cables 116 connected to individual adapters of the adapter bank 126 when the adapter bank 126 is in use or a portion of the adaptor bank 126, as shown in FIG. 1. The cover 204 comprises an inner surface 286, an outer surface 288, securing latches 290, and a hinge portion 292. The cover 204 may be substantially planar and may therefore provide substantially flat inner and outer surfaces 286, 288, to accommodate, for example, identification labels affixed to the inner or outer surfaces 286, 288. Identification labels may decrease difficulty in identifying specific optical fiber cables by providing ample surface area in which to describe or otherwise label specific optical fiber cables. The cover 204 may be hingedly connected to the base 210, allowing the cover 204 to rotate with respect to the base 210. In other embodiments, the cover 204 may be slidably attached to the base 210. The securing latches 290 may be positioned on the inner surface 286 of the cover 204 and may engage with corresponding cover latches 236 of the base 210 to secure the cover 204 to the base 210 when the cover 204 is in the secured position 206. Although two securing latches 290 are illustrated, additional or fewer securing latches may be included. Also, other securing mechanisms may be used to secure the cover 204 to the base 210, such as a snap-fit mechanism. While the cover 204 is illustrated as being detachable from the base 210 in FIGS. 3-5, in other embodiments the cover 204 may not be detachable from the base 210. The cover may be made of any suitable material including, without limitation, a transparent or translucent material.

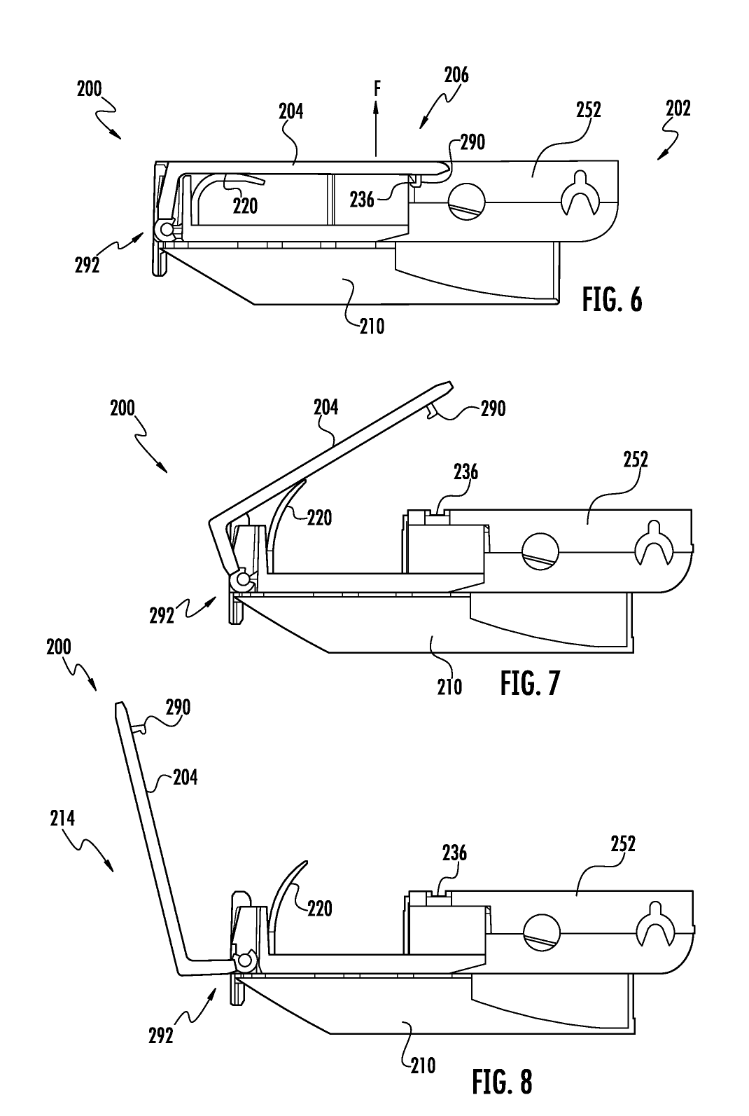

Referring now to FIGS. 6-8, the drop handle 200 is depicted in a side view in various positions. In FIG. 6, the cover 204 is in the secured position 206, in FIG. 7 the cover 204 is shown moving into the unsecured position 214, and in FIG. 8, the cover 204 is in the unsecured position 214. Referring first to FIG. 6, the cover 204 may be moved from the secured position 206 by applying an upward force F to the cover 204. As the upward force F is applied as shown in FIG. 6, the cover 204 rotates about the hinge portion 292, away from the secured position 206 as shown in FIG. 6 and towards the unsecured position 214 as shown in FIG. 8. The flexible retainers 220, shown engaged with the cover 204 in the secured position 206, begin returning to a default form as the contact surface between the cover 204 and the flexible retainers 220 is reduced. In the unsecured position 214, depicted in FIG. 8, the cover 204 may be configured to stand alone, such that a user may access the plurality of adapters on the fiber optic cassette 110. The flexible retainers 220 may prevent pinching of optical fiber cables when the drop handle 200 or cover 204 is moved. In some embodiments, the flexible retainers 220 may still contact the cover 204 in the unsecured position 214.

Referring now to FIGS. 9-11, the drop handle 200 is depicted moving from the stored position 202 and secured position 206 in FIG. 9 along direction 201 towards an access position 213 and unsecured position 215 in FIG. 11. In this embodiment, to release the drop handle 200 from the stored position 202, the release protrusions 134, 138 of the fiber optic cassette 110 (as shown in FIGS. 1, 2) may be depressed or actuated such that the release protrusions 134, 138 are no longer engaged with the respective release apertures 280, 282 of the drop handle 200. The drop handle 200 may then rotate with respect to the cassette body 112 along direction 201. As the drop handle 200 rotates, the locking tabs 270, 272 of the hinges 254, 256 disengage from the first detents 251, 255 and move towards the second detents 253, 257. The detent positions may provide a more secure engagement with the first and second locking tabs 270, 272, and a higher amount of force may be needed to dislodge the drop handle 200 when the locking tabs 270, 272 are engaged with the detents. Alternatively, in some embodiments a user may manipulate the drop handle 200 or move the drop handle 200 by manually applying force to the finger grips 230 instead of the release protrusions 134, 138. In this embodiment, the locking tabs 270, 272 may be of limited dimension, such that any resisting force generated by the locking tabs 270, 272 may be overcome by torque applied to the finger grips 230, and the fiber optic cassette system 100 is not damaged.

Additionally, the first and second connecting arms 130, 132 of the fiber optic cassette 110 include a notch portion 310. A portion 312 of the cover 204 rests on the notch portion 310 when the cover 204 is in the secured position 206. The notch portion 310 applies a force to the cover 204 when the release protrusions 134, 138 are actuated and the drop handle 200 is moved from the stored position 202. The force applied to the cover 204 by the notch portion 310 dislodges the cover 204 from the secured position 206, such that the securing latch 290 and the cover latch 236 of the base 210 are disengaged. Accordingly, when the drop handle 200 is moved from the stored position 202 while the cover 204 is in the secured position 206, the cover 204 will be automatically dislodged from the secured position 206, thereby preventing the cover 204 from displacing any optical fibers or the plurality of adapters.

Thus, various embodiments of fiber optic cassette systems have been described, in which a fiber optic cassette is connected to a drop handle, and the drop handle protects and identifies fiber optic cables positioned in the fiber optic cassette system. Furthermore, the inclusion of a drop handle according to the embodiments described above may protect fiber optic cables while not exceeding physical constraints of optical fibers such as minimum bending radii.

Many modifications and other embodiments will come to mind to one skilled in the art to which the embodiments set forth herein pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A drop handle comprising:
a base comprising a first end, a second end, and a cover latch;
a cover connected to the base, the cover comprising a securing latch positioned on an inner surface, wherein the securing latch is configured to engage with the cover latch of the base to secure the cover to the base in a secured position;
a flexible retainer removably attached to the base and configured to contact the cover in the secured position;
a first connecting member positioned near the first end of the base, the first connecting member comprising a first hinge that is configured to rotatably connect the drop handle to a cassette, the first hinge operable to releasably lock the drop handle in a first position and a second position;
a second connecting member positioned near the second end of the base, the second connecting member comprising a second hinge that is configured to rotatably connect the drop handle to the cassette; and
a release aperture disposed on at least one of the first and second connecting members, the release aperture configured to receive a corresponding release protrusion on the cassette.

2. The drop handle of claim 1, wherein the cover is hingedly connected to the base.

3. The drop handle of claim 2, wherein the cover is configured to rotate, with respect to the base, from the secured position to an unsecured position.

4. The drop handle of claim 1, wherein the first hinge comprises a first locking tab configured to releasably lock the drop handle in the first position or the second position.

5. The drop handle of claim 1, wherein the first position is a stored position and the second position is an access position.

6. The drop handle of claim 1, wherein the second hinge comprises a second locking tab configured to releasably lock the drop handle in the first position or the second position.

7. The drop handle of claim 1, further comprising a second flexible retainer removably attached to the base and configured to contact the cover in the secured position.

8. The drop handle of claim 1, wherein the cover has a substantially flat outer surface.

9. A drop handle comprising:
a base comprising a first end, a second end, and a cover latch,
a protective cover hingedly attached to the base forming an optical fiber cavity, the protective cover comprising a securing latch configured to engage the cover latch of the base and secure the protective cover in a secured position;
a first connecting member positioned near the first end of the base, the first connecting member comprising a first hinge that is configured to rotatably connect the drop handle to a cassette, the first hinge operable to releasably lock the drop handle in a first position and a second position, and a first release aperture configured to engage with a corresponding release protrusion on a cassette;
a second connecting member positioned near the second end of the base, the second connecting member comprising a second hinge that is configured to rotatably connect the drop handle to the cassette, the second hinge operable to releasably lock the drop handle in the first position and the second position, and a second release aperture configured to engage with a corresponding release protrusion on a cassette;
wherein the second release aperture is opposite and axially-aligned with the first release aperture; and
the protective cover is rotatable, with respect to the base, from the secured position to an unsecured position.

10. The drop handle of claim 9, wherein each of the first hinge and the second hinge comprise a locking tab configured to releasably lock the drop handle in the first position or the second position.

11. The drop handle of claim 9, further comprising a second flexible retainer removably attached to the base and configured to contact the protective cover in the secured position.

12. The drop handle of claim 9, wherein the protective cover has a substantially flat outer surface.

13. A fiber optic cassette system, the cassette system comprising:
a cassette body;
a first connecting arm disposed at one end of the cassette body;
a second connecting arm disposed at an end of the cassette body opposite the first connecting arm;
a plurality of adapters positioned in between the first connecting arm and the second connecting arm;
a drop handle comprising:
a base comprising a first end, a second end, and a cover latch,
a cover connected to the base, the cover comprising a securing latch positioned on an inner surface, wherein the securing latch is configured to engage with the cover latch of the base to secure the cover to the base in a secured position,
a flexible retainer removably attached to the base and configured to contact the cover in the secured position,
a first connecting member positioned near the first end of the base, the first connecting member comprising a first hinge that is configured to rotatably connect the drop handle to the cassette body, the first hinge operable to releasably lock the drop handle in a first position and a second position,
a second connecting member positioned near the second end of the base, the second connecting member comprising a second hinge that is configured to rotatably connect the drop handle to the cassette body, the second hinge operable to releasably lock the drop handle in the first position and the second position, and
a first release aperture disposed on the first connecting member and a second release aperture disposed on the second connecting member, the first and second release apertures configured to receive corresponding release protrusions on the cassette body;
wherein the first connecting arm comprises a first hinge receiving feature and a first release protrusion, the first hinge receiving feature configured to receive the first hinge of the drop handle and the first release protrusion configured to engage the first release aperture of the drop handle;
wherein the second connecting arm comprises a second hinge receiving feature and a second release protrusion, the second hinge receiving feature configured to receive the second hinge of the drop handle and the second release protrusion configured to engage the second release aperture of the drop handle; and
wherein the drop handle is configured to rotate relative to the cassette body between the first position and the second position.

14. The cassette system of claim 13, wherein the cover envelops a substantial majority of the plurality of adapters when oriented in the secured position.

15. The cassette system of claim 13, wherein the cover latch of the base disengages the securing latch of the cover as the drop handle is moved from the first position to the second position.

16. The cassette system of claim 13, wherein the first position is a stored position and the second position is an access position.

17. The cassette system of claim 13, wherein the first hinge receiving feature comprises a first detent and the second hinge receiving feature comprises a second detent.

18. The cassette system of claim 13, wherein the first hinge and the second hinge comprise a locking tab configured to releasably lock the drop handle in the first position or the second position.

19. The cassette system of claim 13, further comprising a second flexible retainer removably attached to the base and configured to contact the cover in the secured position.

20. The cassette system of claim 13, wherein the cover has a substantially flat outer surface.
